(19) United States
(12) Patent Application Publication
(10) Pub. No.: US 2026/0204974 A1
(43) Pub. Date: Jul. 16, 2026

(54) AXIAL-FLUX ELECTRIC MACHINE AND METHOD FOR ASSEMBLING SUCH A MACHINE

(71) Applicants: AMPERE, Boulogne Billancourt (FR); WHYLOT, Cambes (FR)

(72) Inventor: Damien BIROLLEAU, Guyancourt (FR)

(73) Assignees: AMPERE, Boulogne Billancourt (FR); WHYLOT, Cambes (FR)

(21) Appl. No.: 19/136,114

(22) PCT Filed: Dec. 1, 2023
(86) PCT No.: PCT/FR2023/051893

§ 371 Date: Jun. 5, 2025

(30) Foreign Application Priority Data
Dec. 9, 2022 (FR) 2213114

(51) Int. Cl. H02K 3/52; H02K 15/33; H02K 21/24

(52) U.S. Cl. CPC H02K 3/522; H02K 15/33; H02K 21/24; H02K 2203/09

(57) ABSTRACT

An axial-flux electric machine includes a housing and first and second stators including first and second circular buses having conductive tracks on which are arranged connection terminals allowing connection to the coils of the stators and which are supplied by supply phases. The circular buses and the coils are interchangeable between stators. The machine also includes indexing devices that position the circular buses in the housing so as to place facing a connection terminal of the first circular bus and a connection terminal of the second circular bus that are supplied by a same supply phase.

This invention relates to the fields of electrical engineering and mechanical engineering, and more specifically concerns an axial-flux electric machine.

The electric or hybrid electric vehicles currently use electric traction or propulsion motors, which are often radial-flux electric machines, i.e. the stator windings of such a machine generate a magnetic flux in a radial direction with respect to an axial direction corresponding to the axis of rotation of the machine.

In order to reduce the size of such a motor used for the traction or the propulsion of an electric vehicle, it is envisaged that an axial-flux electric machine will be used instead of a radial-flux electric machine. This type of machine is generally more compact, at least in an axial direction corresponding to the axis of rotation of the machine, which gives it a discoidal appearance.

Some of these axial-flux electric machines have an advantageous configuration, in particular the double-stator axial-flux electric machines comprising two wound stators, preferably three-phase, between which a rotor fitted with permanent magnets rotates. With this type of machine, the radius of the axial-flux electric machine is smaller than that of a single-stator machine, at equivalent power. However, the manufacture and the assembly of such a dual-stator machine is complex and costly, particularly because of the electrical connections to be made to the coils of each of the stators of the machine. In fact, on the two stators of the machine which are opposite each other, the coils facing each other must be supplied by the same supply phase, while having a current flowing through these coils in the same direction, so that they generate a magnetic flux of the same direction and the same sense. These requirements mean that the connections of the coils are prone to errors. Positioning systems are therefore required to assemble the electric machine, firstly to correctly connect the coils of each stator to conductor buses, each connected to a supply phase of the electric machine, and secondly to electrically connect these conductor buses to a power electronics module (comprising an inverter) itself connected to a high-voltage battery of the vehicle. In particular, the winding direction on the coils of the machine is reversed from one stator to another, and the conductor buses connected to the coils of the machine have different configurations from one stator to another. These different parts for each stator and these positioning systems make it expensive to manufacture and assemble the machine.

The present invention at least partially remedies the disadvantages of the prior art, by providing an axial-flux three-phase electric machine, and a method for assembling such a machine, which reduce the diversity of parts used to manufacture the machine, and reduce the risk of error during its assembly.

To this end, the present invention provides a three-phase axial-flux electric machine comprising:
a housing comprising a first segment housing a first stator and a second segment housing a second stator,
a rotor capable of rotating about an axis of rotation, housed in the housing between the first stator and the second stator,
the first stator and the second stator, which each comprise coils and which respectively comprise a first and a second three-phase circular bus, the first and second circular buses comprising each conductive tracks on which are arranged connection terminals of the coils,
and at least a first, a second and a third supply phase connection on the first and on the second stator, each electrically connected to one of the conductive tracks of the first and of the second circular bus respectively, and each configured to be supplied by a first, a second and a third supply phase respectively at the output of at least one power electronics module, the electric machine being characterized:
in that the first circular bus, the second circular bus and the coils of the first and of the second stator are structurally identical, and
in that it further comprises at least one first device for indexing a position of the first circular bus in the first housing segment, and at least one second device for indexing a position of the second circular bus in the second housing segment, the first and second indexing devices being able to position in the housing a predetermined connection terminal from among the connection terminals of the first circular bus, electrically connected to the second phase connection of the first stator, opposite a predetermined connection terminal among the connection terminals of the second circular bus, electrically connected to the second phase connection of the second stator, the electrical connections of the first and third phase connections to the conductive tracks being reversed on the first stator relative to the second stator.

By “opposite” or “face to face” or “in front of” in this application, we mean radially and angularly at the same position, the radial and angular directions being defined in relation to the same axial direction given by the axis of rotation of the rotor, even if intermediate parts separate the elements considered face to face.

The indexing devices are, for example, pins attached to the circular buses and nesting into corresponding locations on each housing segment. Alternatively, they may be a mark on the predetermined terminal of each circular bus. The angular position of the indexing device on each circular bus is determined in relation to the angular position of the predetermined connection terminal of the circular bus.

Thanks to the invention, only the first indexing device and the second indexing device are needed to avoid the electrical connection errors when assembling the machine. The first circular bus, the second circular bus and the coils of the first and of the second stator are structurally identical, which means that the circular buses and the coils are interchangeable from one stator to another. In particular, the coils on the first stator and the second stator have the same winding direction. This reduction in the variety of parts saves on manufacturing costs and simplifies assembly.

It should be noted that in the invention, each circular bus comprises its own conductive tracks and the connection terminals connecting these conductive tracks to the coils of the stators. As a result, the circular buses are not symmetrical to each other, with respect to a plane orthogonal to the axis of rotation of the electric machine, when the circular buses are housed in the housing of the machine. If this were the case, there would be no need to reverse the first and second phase connections on the two stators to operate the machine.

The invention also saves a production mold for a second circular bus, since the production mold for the first circular bus may be used to produce the second circular bus, and therefore saves a separate production line for this second circular bus too.

It should be noted that the second phase connection to which the predetermined connection terminals are connected is supplied by any supply phase but is identical for both predetermined connection terminals, the important thing being that the other phase connections on the first stator are reversed with respect to the second stator, as will be described in detail. In addition, the circular buses form structures that angularly position the connection terminals of the coils, but these structures are not necessarily completely circular or closed.

According to an advantageous characteristic of the electric machine according to the invention, the first indexing device is a first terminal block attached to the first circular bus and adapted to nest into a dedicated location of the first housing segment, and the second indexing device is a second terminal block attached to the second circular bus and capable of nesting into a dedicated location of the second housing segment, the first terminal block and the second terminal block comprising the first, the second and the third phase connection of the first circular bus and of the second circular bus respectively.

Advantageously, the assembly of first circular bus and first terminal block connected to each other form a structure identical to that formed by the assembly of second circular bus and second terminal block connected to each other. Structurally means that the mechanical parts are identical, but their connections to the supply phases may differ. The first and second terminal blocks are positioned, for example, in facing locations in the housing, and in the same way on each circular bus, so as to be structurally interchangeable from one stator to another, thanks to a judicious choice of predetermined connection terminals. This prevents electrical connection errors.

In one embodiment of the electric machine according to the invention, the coils of the first stator are connected in star, the coils of the second stator are connected in star, the connection terminals of the coils of the first and respectively of the second stator define, on one face of the first and respectively of the second circular bus having the connection terminals, the same sequence being repeated in rotation through a predefined angle in the clockwise direction, and the position of the predetermined connection terminal on the first circular bus and the position of the predetermined connection terminal on the second circular bus are identical in the sequence of connection terminals of the first and second circular buses. In other words, the predetermined connection terminal on either of the first and second circular buses is chosen from any of the connection terminals connected to the second phase connection.

Preferably in this embodiment of the machine according to the invention, the second phase connection of the first terminal block is angularly located at the same position as the predetermined connection terminal of the first circular bus. Similarly, the second phase connection of the second terminal block is preferably located at the same angular position as the predetermined connection terminal of the second circular bus. So, although the phase connections are reversed on the first and second terminal blocks, simply place the two terminal blocks exactly opposite each other to position the first stator and the second stator correctly in the housing.

Alternatively in this embodiment of the invention, when the number of pole pairs of the electric machine is odd, the second phase connection of the first terminal block is located angularly at 180° with respect to the predetermined connection terminal of the first circular bus. Preferably in this alternative, the second phase connection of the second terminal block is located at an angle of 180° to the predetermined connection terminal of the second circular bus, so as to have to place the first terminal block exactly opposite the second terminal block in order to position the first and second stator correctly in the housing of the electric machine.

Finally, in this embodiment of the invention, the first circular bus and the second circular bus each preferably comprise a conductive track of neutral point to which all the coils of the first stator and all the coils of the second stator are connected respectively.

In another embodiment of the invention, the coils of the first stator are connected in delta, the coils of the second stator are connected in delta, the connection terminals of the coils of the first and respectively of the second stator define, on a face of the first and of the second circular bus respectively having the connection terminals, the same sequence being repeated in rotation through a predefined angle in the clockwise direction, and the predetermined connection terminal on the first circular bus corresponds to the connection terminal immediately following the predetermined connection terminal on the second circular bus in the sequence of connection terminals of the first and second circular buses.

Preferably in this other embodiment of the invention, the second phase connection of the first terminal block is located angularly between two connection terminals of the first circular bus, electrically connected to the second phase connection of the first stator. Also preferably in this other embodiment of the invention, the second phase connection of the second terminal block is located angularly between two connection terminals of the second circular bus, electrically connected to the second phase connection of the second stator. As the first and second indexing devices are angularly positioned between two successive connection terminals connected to the second phase connection on the first and second circular bus respectively, it is sufficient to place the first terminal block exactly opposite the second terminal block to position the first and second stators correctly in the housing of the electric machine.

Finally, depending on the star or delta connection of the coils of the electric machine according to the invention, the angular position of the indexing device on each circular bus is determined, for example, with respect to the angular position of a connection terminal for the circular bus, electrically connected to the second phase connection, or respectively with respect to the angular positions of two successive circular bus connection terminals electrically connected to the second phase connection. This makes it easy to place all the connection terminals connected to the second phase connection of the two circular buses face to face.

According to an advantageous characteristic of the electric machine according to the invention, the conductive tracks of the first circular bus form an external ring connected to the third phase connection, an intermediate ring surrounded by the external ring and connected to the second phase connection, and an internal ring surrounded by the intermediate ring and connected to the first phase connection, while
the conductive tracks of the second circular bus form an external ring connected to the first phase connection, an intermediate ring surrounded by the external ring and connected to the second phase connection, and an internal ring surrounded by the intermediate ring and connected to the third phase connection,
the first, second and third phase connections of the first terminal block being respectively placed opposite the first, second and third phase connections of the second terminal block.

This axial symmetry of the phase connections of the two circular buses in relation to a plane orthogonal to the axis of rotation of the rotor further reduces the risk of connection errors. It also allows the phase connections to be electrically connected to the power electronics module without crossing the electrical conductors making these electrical connections.

In order to further facilitate the creation of these electrical connections, preferably the electric machine according to the invention also comprises conductive bars electrically connecting the first, second and third phase connections of the first terminal block to the first, second and third phase connections respectively of the second terminal block, the conductive bars each comprising an electrical connection terminal suitable for receiving a connecting member for electrical connection to a supply phase of said at least one power electronics module.

The invention also relates to a method for assembling a three-phase axial-flux electric machine according to the invention, comprising the steps of:
connecting electrically the first, second and third supply phase connections to the first circular bus,
connecting electrically the first, second and third supply phase connections to the second circular bus,
positioning the first circular bus in the first housing segment using the at least one first indexing device,
positioning the second circular bus in the second housing segment using the at least one second indexing device,
connecting electrically the coils of the first stator to the connection terminals of the first circular bus,
connecting electrically the coils of the second stator to the connection terminals of the second circular bus,
installing the rotor,
closing the housing.

Of course, these steps do not necessarily follow the order of this list. In particular, the electrical connection steps may be performed before or after the electrical connection steps, especially when the indexing devices do not comprise the phase connections. Furthermore, if the housing comprises two separate half-housings, each defining a segment of the housing housing one of the stators, the two half-housings having to be screwed together to close the housing, then the rotor installation step is carried out after the circular bus positioning steps. In this case, the rotor is inserted between the two half-housing before they are screwed together. On the other hand, if the housing is closed by a cover, the rotor may be placed before one of the circular buses is positioned.

When the indexing devices are the first and second terminal blocks, the steps of electrically connecting the first, second and third supply phase connections to the first circular bus and to the second circular bus correspond to attaching the first terminal block to the first circular bus and attaching the second terminal block to the second circular bus, and the steps of positioning the first circular bus in the first housing segment and positioning the second circular bus in the second housing segment include positioning the first terminal block and respectively the second terminal block in a dedicated location of the first housing segment and respectively the second housing position.

Other characteristics and advantages of the invention will become apparent from the following description, on the one hand, and from a number of examples of embodiment given by way of indication and without limitation with reference to the attached schematic drawings, on the other hand, wherein:

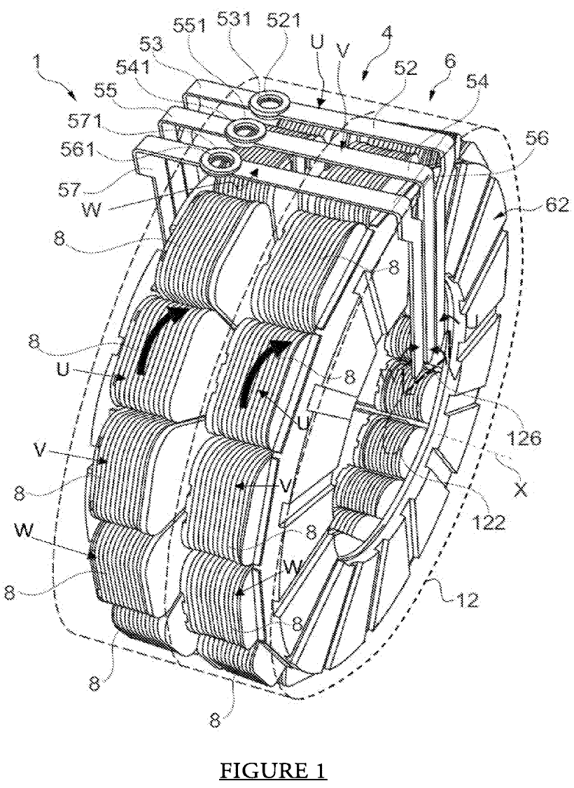

FIG. 1 shows a perspective view of a three-phase axial-flux electric machine according to the invention, in a first embodiment of the invention,

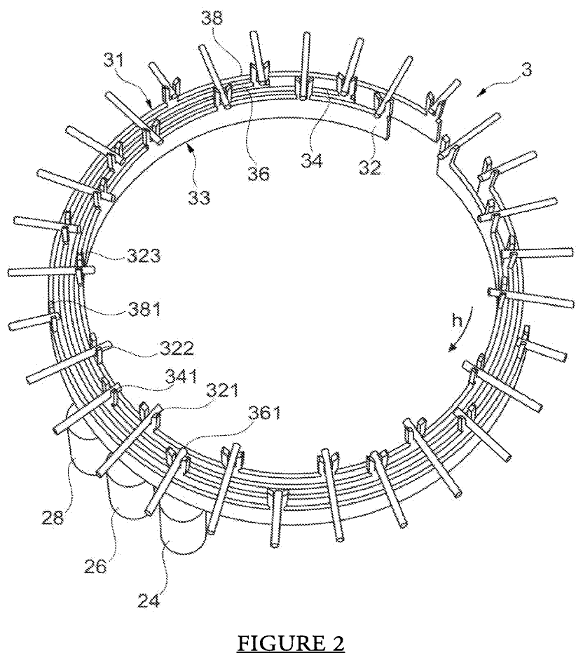

FIG. 2 shows a perspective view of a first circular bus of the electric machine of FIG. 1, so as to reveal a face of the first circular bus comprising coil connection terminals,

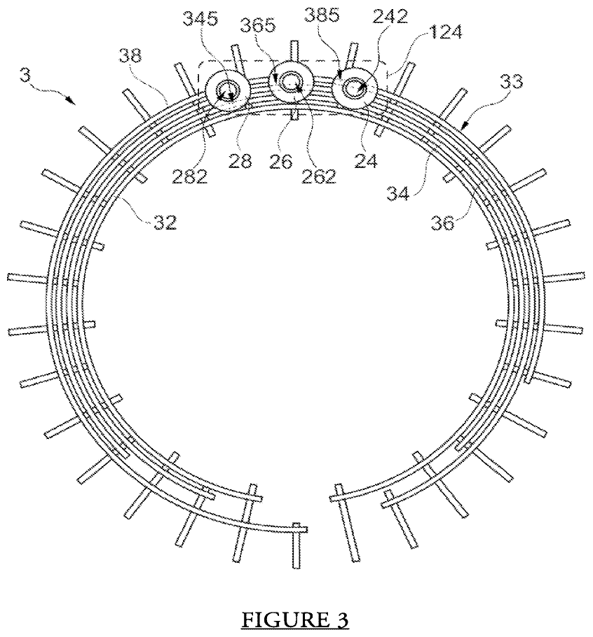

FIG. 3 is a perspective view of the first circular bus in FIG. 2, showing a face opposite the face comprising the coil connection terminals,

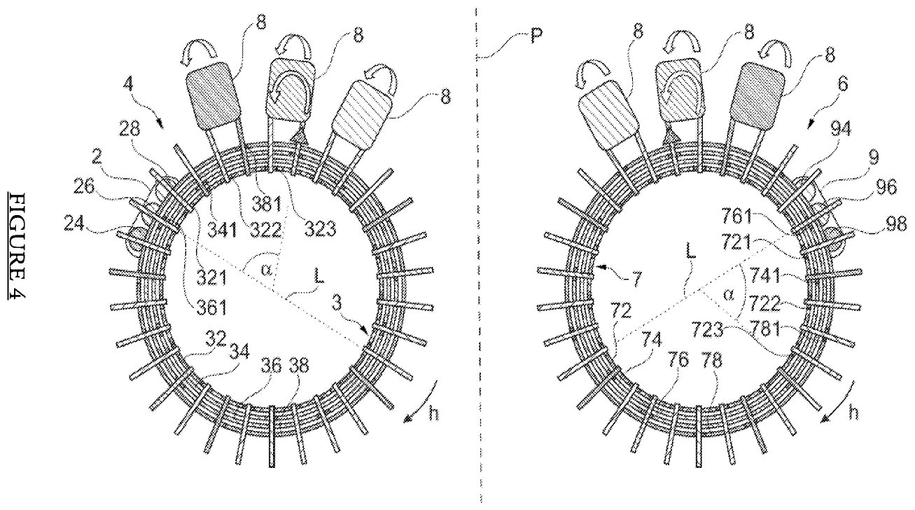

FIG. 4 schematically illustrates stators of the electric machine of FIG. 1, wherein the coils are connected in star and wherein terminal blocks comprising phase connections face each other when the stators are mounted in the electric machine,

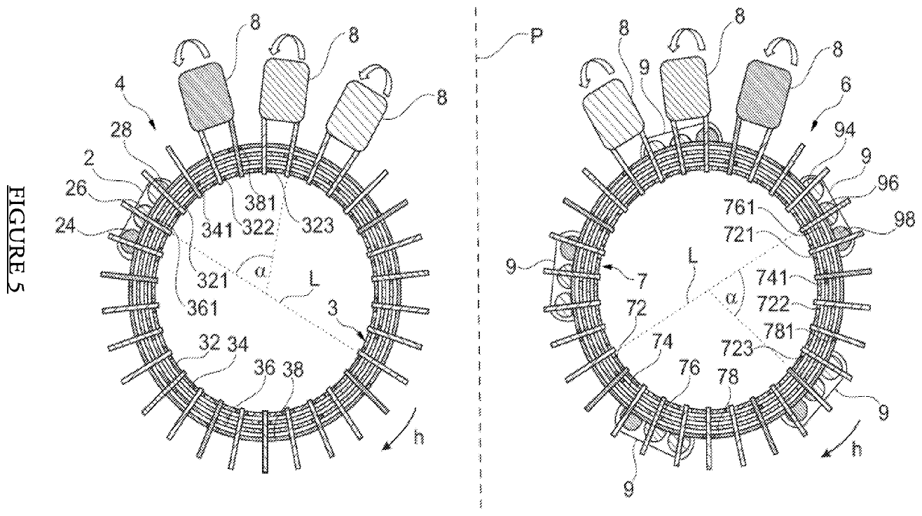

FIG. 5 schematically illustrates alternative embodiments of FIG. 4, wherein the terminal blocks comprising the phase connections are angularly located at a predetermined angle to each other when the stators are mounted in the electric machine,

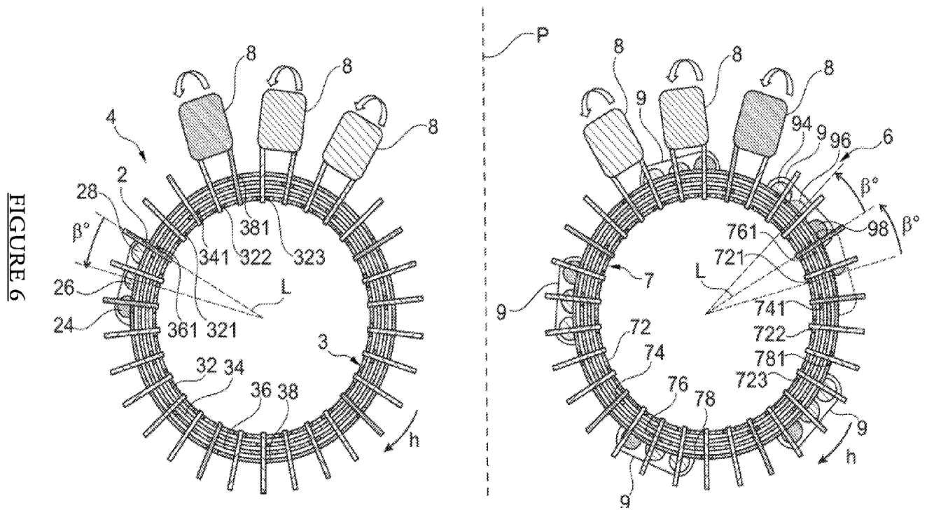

FIG. 6 schematically illustrates further alternative embodiments of FIG. 4, wherein the terminal blocks comprising the phase connections are angularly located at any angle to each other when the stators are mounted in the electric machine,

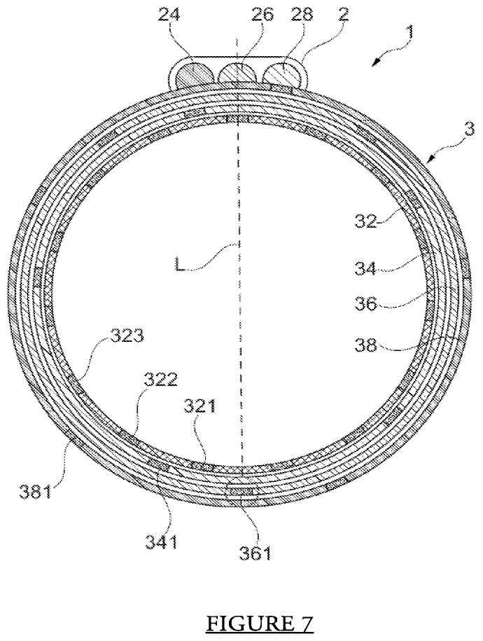

FIG. 7 schematically illustrates a variant of FIG. 4, wherein the terminal blocks comprising the phase connections are located angularly opposite the terminal blocks in FIG. 4,

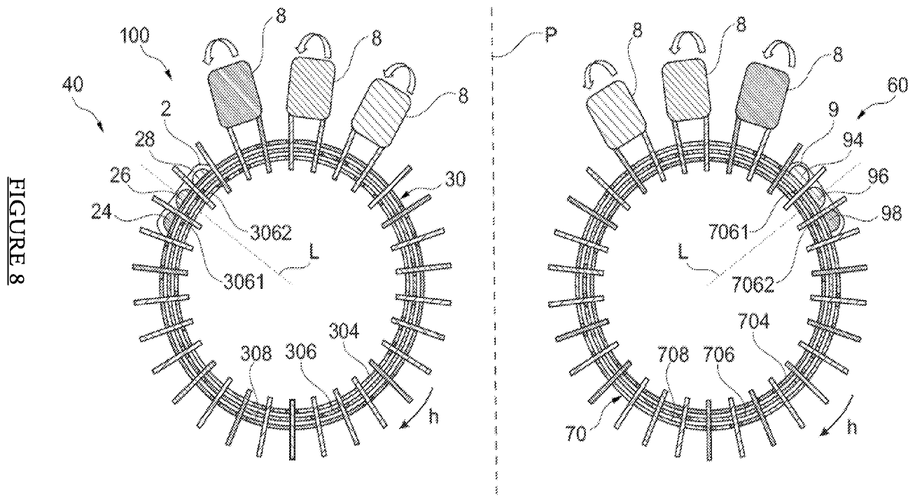

FIG. 8 schematically illustrates stators of an electric machine according to the invention, in a second embodiment of the invention, wherein the coils of the machine are connected in a delta configuration, and

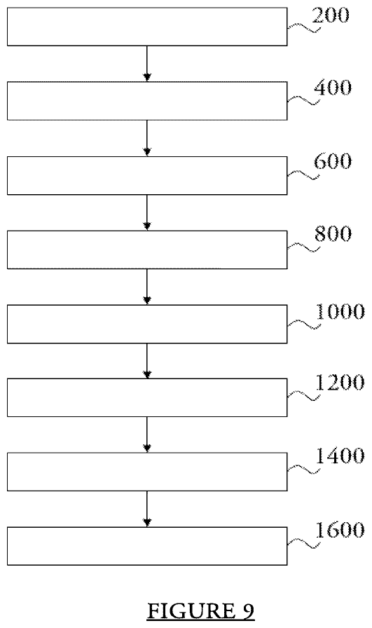

FIG. 9 shows steps in a method for assembling an electric machine according to the invention. According to a first embodiment of the invention shown in FIG. 1, a three-phase axial-flux electric machine 1 comprises a first stator 4 and a second stator 6. Each stator 4, 6 is substantially circular in shape and centered around an axis of rotation X of a rotor not shown, provided with permanent magnets and housed between the two stators 4, 6. In this application, the axis of rotation X defines an axial direction, a radial direction being orthogonal to this axial direction and passing through a radius of the rotor. An angular position in this application is defined in degrees on a circle centered on the axis of rotation X and comprised in a plane orthogonal to the axial direction.

Each stator 4, 6 comprises a plurality of coils 8 attached to a magnetic steel yoke. The coils 8 of the second stator 6 are thus attached to the yoke referenced 62 in FIG. 1. In a known way, the coils 8 surround stator teeth made of magnetic steel extending axially on the yoke of each stator 4, 6. More precisely, the copper wire of each coil 8 is wound onto an electrically insulating winding support, for example made of synthetic polymer material, which is then nested onto a stator tooth. Of course, other embodiments for the coils and their connection to the stators are possible.

In a known way, each coil 8 is configured to conduct an electric current from a first, second or third supply phase respectively U, V or W to the output of a power electronics module (not shown) supplying a three-phase current. So when the electric machine 1 is supplied with current, the first stator 4 angularly comprises a repetition of a sequence of three coils supplied by the first, second and third supply phases U, V, W, i.e. five pairs of stator poles (fifteen coils 8 in total). The second stator 6 also comprises five pairs of poles, with each coil 8 supplied by a supply phase U, V or W facing a coil 8 of the first stator 4 supplied by the same supply phase.

As may be seen in FIG. 2, the electrical connection of the coils 8 of each stator 4, 6 to the supply phases U, V, W is via a three-phase circular bus, the first three-phase circular bus 3 shown in FIG. 2 being that of the first stator 4. The second three-phase circular bus 7 of the second stator 6 is referenced in FIGS. 4, 5 and 6 and is structurally identical to the first circular bus 3, which will therefore only be detailed in relation to FIGS. 2 and 3.

In this first embodiment of the invention, the coils 8 of the electric machine 1 are connected in a star configuration. The first circular bus 3 therefore comprises four conductive tracks 32, 34, 36 and 38 which are unclosed circular conductive bars in the form of unclosed cylindrical rings. The conductive track 32 is central and corresponds to a neutral point of the stator 4.

The conductive track 34 corresponds to an internal cylindrical ring surrounding the central conductive track 32, and is electrically connected to a first phase connection 28 configured to be connected to the first supply phase U.

The conductive track 36 corresponds to an intermediate cylindrical ring surrounding the conductive track 34, and is electrically connected to a second phase connection 26 configured to be connected to the second supply phase V.

The conductive track 38 corresponds to an external cylindrical ring surrounding the conductive track 36, and is electrically connected to a third phase connection 24 configured to be connected to the third supply phase W.

Alternatively, other conductive track arrangements are of course possible. In particular, the conductive tracks are not nested but arranged radially at the same level. They may also take a shape other than a cylindrical ring, for example a wire-shape forming a polygon.

On the face 31 of the first circular bus 3 visible in FIG. 2, connection terminals for connection to the coils 8 are evenly spaced at an angle on the conductive tracks 32 to 38 of the first circular bus 3. The wire ends of each coil 8 are shown clipped into these connection terminals. Of course, other types of attachment to these connection terminals are possible, for example by laser soldering or brazing. The longer ends are attached to the central neutral conductive track 32.

In the electric machine 1, according to the invention, the winding direction of the copper wire on each coil 8 is identical from one coil to the next, and the coils 8 are interchangeable from one stator to the next. As a result, the coils 8 facing each other have their winding direction axially reversed with respect to each other, and are supplied with an electric current flowing in the same direction as represented by the thick solid line arrows, i.e. generating a magnetic flux flowing in the same direction in the axial direction. The copper wire used has a round, square or rectangular cross-section.

The repetition of the sequence of three coils 8 mentioned above results in a clockwise repetition h on the face 31 of a sequence of connection terminals 361, 321, 341, 322, 381 and 323 repeating every 72 degrees, i.e. 360 degrees divided by the number of pole pairs in the electric machine to generalize to any number of pole pairs. The second, fourth and sixth connection terminals 321, 322 and 323 of this series of connection terminals belong to the central neutral point conductive track 32.

The first connection terminal 361 of the series of connection terminals belongs to the conductive track 36 electrically connected to the second phase connection 26, the third connection terminal 341 of the series of connection terminals belongs to the conductive track 34 electrically connected to the first phase connection 28 and the fifth connection terminal 381 of the series of connection terminals belongs to the conductive track 38 electrically connected to the third phase connection 24.

On the face 33 opposite the face 31 of the first circular bus 3, shown in FIG. 3, it may be seen that the phase connections 24, 26 and 28 are in the form of metal cylinders. The non-visible base of each cylinder 24, 26, 28 is recessed to receive an axial extension 385, 365 or 345 of a respective conductive track 38, 36 or 34 soldered into the hollow cylinder. These axial extensions extend angularly only along a segment of the base of the corresponding cylinder and are represented by dotted lines in FIG. 3. Alternatively, other types of attachment of the phase connections 24, 26 and 28 to the circular buses of the first stator 4 are of course possible.

The bases, visible in FIG. 3, of the cylinders corresponding to the phase connections 24, 26 and 28, comprise threaded orifices 242, 262 and 282 respectively, allowing them to be electrically connected to the free ends of conductive bars 57, 55 and 53 respectively of the first stator 4, visible in FIG. 1, these free ends being arranged close to the axis of rotation X of the rotor. In FIG. 1, the first and second circular buses and their respective phase connections are not shown.

Phase connections 94, 96 and 98 of the second circular bus 7 shown in FIGS. 4 to 6 are symmetrically connected to the free ends of conductive bars 52, 54 and 56 respectively of the second stator 6, shown in FIG. 1. Given the position of the free ends of the conductive bars 52 to 57 in FIG. 1, it may be guessed that the circular buses 3, 7 are arranged on an internal radial periphery of the coils 8, around a hub of the rotor. Alternatively, the circular buses of the electric machine according to the invention are arranged on an external radial periphery of the coils 8. In another variant, the conductive tracks of the circular buses of the electric machine according to the invention are axially offset from one another, being arranged radially at the same level.

The other ends of the conductive bars 53, 55, 57 of the first stator 4 comprise respective electrical connection terminals 531, 551, 571 in the form of eyelets, these electrical connection terminals being superimposed on respective electrical connection terminals 521, 541, 561, also in the form of eyelets and disposed at the other ends of the respective conductive bars 52, 54, 56 of the second stator 6. These six electrical connection terminals 521, 531, 541, 551, 561, 571 superimposed in pairs allow three electrical connecting members to be connected to the power electronics module, each electrical connecting member electrically connecting the first and second stator 4, 6 to a supply phase U, V or W at the output of the power electronics module.

To mount the first stator 4 opposite the second stator 6 in the electric machine 1, so that the coils 8 facing each other are supplied by the same phase and have a current flowing through them in the same direction, the first stator 4 is housed in a first segment of a housing 12 of the electric machine 1, being positioned angularly by means of a first indexing device.

The housing 12 has a generally cylindrical shape, the bases of this cylindrical shape corresponding to walls of the housing 12, each of which comprises a central hole 122 through which a rotor shaft may pass.

Similarly, the second stator 6 is housed in a second segment of the housing 12 of the electric machine 1, being angularly positioned by means of a second indexing device.

In this first embodiment of the invention, the first indexing device is a first terminal block 2 (referred to in FIGS. 4 to 6) comprising the phase connections 24, 26 and 28 of the first circular bus 3, and the second indexing device is a second terminal block 9 comprising the phase connections 94, 96 and 98 of the second circular bus 7. These first and second terminal blocks 2, 9 each form a block over-molded with their phase connections, this over-molding being made of an electrically insulating material. Other versions of terminal blocks 2, 9 are of course possible.

The first terminal block 2 is inserted into a corresponding hole 124 (referenced in FIG. 3) in a wall of the housing 12, this hole allowing access to threaded orifices 242, 262 and 282 for screwing in the respective conductive bars 57, 55 and 53 for connecting the first stator 4 to the power electronics module. Similarly, the second terminal block 9 is inserted into a corresponding hole 126 (referenced in FIG. 1) in a wall of the housing 12, this hole 126 allowing access to the threaded orifices of the phase connections 94, 96, 98 for screwing in the respective conductive bars 52, 54 and 56 for connecting the second stator 6 to the power electronics module.

Alternatively, the housing may not comprise holes for inserting the terminal blocks, particularly when they are connected to the power electronics module via an output on an external radial periphery of the housing. In this case it is necessary to ensure, for example, that the terminal blocks are located axially opposite each other, for example visually, when this condition is sufficient to correctly position the connection terminals of the electric machine angularly, in a similar way to the example given in FIG. 4.

In the example of the first embodiment of the invention shown in FIG. 4, the first and second stators 4, 6 are shown unmounted in the electric machine 1, so as to see the faces of their respective circular buses 3, 7 which comprise connection terminals for connection to their coils 8. Only three coils 8 are shown on each stator 4, 6 for simplicity. The winding directions of the coils 8 are represented by thick solid arrows above the coils 8, the direction of current flow is represented by thick solid arrows in one of the coils 8 of each stator 4, 6.

FIG. 4 shows the first stator 4 with the sequence of connection terminals 361, 321, 341, 322, 381 and 323 repeated every 72 degrees in a clockwise direction h on the face 31, this angle being referenced a in FIG. 4.

It should be noted that the invention may be generalized to an electric machine having more than five pairs of poles by taking the angle α equal to 360 degrees divided by the number of pairs of poles of the electric machine in question.

Similarly, on the second stator 6, a sequence of connection terminals 761, 721, 741, 722, 781 and 723, repeated at an angle α, may be seen repeating in the clockwise direction h on the face presenting the connection terminals of the second circular bus 7. This sequence of connection terminals is structurally identical to the sequence of connection terminals 361, 321, 341, 322, 381 and 323 of the first circular bus 3.

The assembly of first circular bus 3 and first terminal block 2 connected to each other forms a structure identical to that formed by the assembly of second circular bus 7 and second terminal block connected to each other. Only the power supply differ from these assemblies.

In particular:
the connection terminal 761 belongs to a conductive track 76 connected to the second phase connection 96 configured to be supplied by the second supply phase V of the power electronics module,
the connection terminal 741 belongs to a conductive track 74 connected to the third phase connection 98 configured to be supplied by the third supply phase W of the power electronics module,
the connection terminal 781 belongs to a conductive track 78 connected to the first phase connection 94 configured to be supplied by the first supply phase U of the power electronics module,
the connection terminals 721, 722, 723 belong to a neutral point conductive track 72.

The second circular bus 7 is angularly rotated with respect to the first circular bus 3, so that by axially positioning the first circular bus 3 facing the second circular bus 7, the line I extending on a radius of the circular bus 3 passing through the connection terminal 361, is axially symmetrical with respect to a plane P orthogonal to the axis of rotation X of the electric machine 1 and passing through the rotor, to a corresponding line I extending on a radius of the circular bus 7 and passing through the connection terminal 761. Note, however, that the other connection terminals are not generally symmetrical to each other with respect to the plane P.

The first phase connection 28 of the first stator 4 is positioned opposite the first phase connection 94 of the second stator 6, the second phase connection 26 of the first stator 4 is positioned opposite the second phase connection 96 of the second stator 6, and the third phase connection 24 of the first stator 4 is positioned opposite the third phase connection 98 of the second stator 6. In particular, this arrangement means that the conductive bars 52, 53, 54, 55, 56 and 57 do not cross each other and are parallel to each other.

As the terminal block and circular bus structures of the first and second stators 4, 6 are identical, this means that the outermost conductive track 38 of the first circular bus is connected to the third phase connection 24 connected to the third supply phase W of the power electronics module, while the outermost conductive track 78 of the second circular bus is connected to the first phase connection 94 connected to the first supply phase U of the power electronics module. This different power supply to the first stator 4 and of the second stator 6 means that, by positioning the first terminal block 2 opposite the second terminal block 9, the coils facing each other may be supplied with the same current, generating a magnetic flux in the same direction. The first terminal block 2 and the second terminal block 9 therefore act as angular indexing devices for the first and second circular buses 3, 7 in the housing 12 of the electric machine 1 by being positioned so that their respective second phase connections 26 and 96 are angularly positioned in the same place as the respective connection terminal blocks 361 and 761, to which they are electrically connected.

On the alternative embodiments in FIG. 5, several possible positions for the second terminal block 9 are shown. This is angularly offset from the first terminal block 2 by a multiple of α, in this case from 1 to 4 α in the clockwise direction h. This offset relates to an arrangement wherein the circular buses 3, 7 of the electric machine are mounted in the housing 12 facing each other. These variants are useful if, for reasons of overall dimension, for example, the conductive bars 52, 54, 56 connected to the second terminal block 9 may not be arranged axially symmetrically with respect to the conductive bars 53, 55, 57 connected to the first terminal block 2. In this case, the holes 124, 126 in the first and second housing segments are angularly offset from each other in the same way when the housing is closed.

In these variants, the second phase connections 26, 96 of the first and second terminal blocks each being angularly disposed in the same position as a connection terminal electrically connected to this second phase connection 26, 96, the connection terminal 361 connected to the second phase connection 26 of the first terminal block 2 remains opposite the connection terminal 761 connected to the second phase connection 96 of the second terminal block 9. In these variants, the arrangement of the connection terminals of the circular buses 3, 7 remains the same as in FIG. 4 when the circular buses 3, 7 face each other.

In the alternative embodiment shown in FIG. 6, the second phase connection 26 of the first terminal block 2 is not angularly positioned at the same position as the connection terminal 361 connected to this second phase connection 26, but is angularly offset relative to this connection terminal 361, by any angle β in the clockwise direction h. In this case, the second terminal block 9 is angularly offset with respect to the first terminal block 2 when they are mounted in the electric machine 1, by an angle 2β counter-clockwise to within a multiple of angle α. The dotted line shows the angular position of the second terminal block 9 corresponding to a position opposite that of the first terminal block 2. This variant maintains the properties of the electric machine 1 according to the invention, i.e. the connection terminals connected to the second phase connection 26, 96 of each stator 4, 6 are located opposite each other in the electric machine 1.

In another embodiment shown in FIG. 7, the second phase connection 26 of the first terminal block 2 is not angularly positioned in the same position as the connection terminal 361 connected to this second phase connection 26, but is angularly offset relative to this connection terminal 361, by an angle of 180°. The second phase connection 96 of the second terminal block 9 is, in this variant, positioned in the same way at 180° to the connection terminal 761 connected to the second phase connection 96 and facing the connection terminal 361. This arrangement is possible if the electric machine 1 comprises an odd number of pole pairs.

In this first embodiment of the invention, the structures of the first and second circular buses 3, 7 are identical, but one must be rotated relative to the other so as to position a connection terminal connected to the second phase connection 26 of the first circular bus 3 opposite a connection terminal connected to the second phase connection 96 of the second circular bus 7, in order to obtain a correct power supply for the coils 8 of the electric machine 1.

In a second embodiment shown in FIG. 8, a three-phase axial-flux electric machine 100 according to the invention comprises a first stator 40 comprising a first circular bus 30 and a plurality of coils 8, only some of which are shown for simplicity. Similarly, the electric machine 100 comprises a second stator 60 comprising a second circular bus 70 and a plurality of coils 8, only some of which are shown for simplicity. The electric machine 100 has many characteristics in common with the electric machine 1, so these characteristics are not repeated here. In particular, the first terminal block 2 is reused to connect the first circular bus 30 to the power electronics module, and the second terminal block 9 is reused to connect the second circular bus 70 to the power electronics module.

The electric machine 100 differs from the electric machine 1 in that its coils are connected in delta. Thus the first circular bus 30 does not comprise a neutral point conductive track, but does comprise:
a circular conductive track 304, electrically connected to the first phase connection 28 and configured to be connected to the first supply phase U;
a circular conductive track 306, electrically connected to the second phase connection 26, surrounding the previous conductive track 304 and configured to be connected to the second supply phase V;
a circular conductive track 308, electrically connected to the third phase connection 24, surrounding the previous conductive track 306 and configured to be connected to the third supply phase W.

The first circular bus 30 comprises, on a face comprising terminals for connection to the coils 8 of the first stator 40, a clockwise repetition h of a series of six connection terminals repeating every 72 degrees, i.e. 360 degrees divided by the number of pole pairs of the electric machine to generalize to any number of pole pairs. The first two connection terminals 3061, 3062 of this sequence belong to the conductive track 306, the next two connection terminals belong to the conductive track 304 and the last two connection terminals of this sequence belong to the conductive track 308.

The assembly of first circular bus 30 and first terminal block 2 connected to each other forms structure identical to that formed by the assembly of second circular bus 70 and second terminal block 9 connected to each other. Only the power supplies for these assemblies are different.

In particular:
two first connection terminals 7061, 7062 of a series of connection terminals identical to the series mentioned above belong to a conductive track 706 connected to the second phase connection 96 and configured to be supplied by the second supply phase V of the power electronics module,
the next two connection terminals in this sequence belong to a conductive track 704 connected to the third phase connection 98 and configured to be supplied by the third supply phase W of the power electronics module,
and the last two connection terminals of this sequence belong to a conductive track 708 connected to the first phase connection 94 and configured to be supplied by the first supply phase U of the power electronics module.

The conductive track 708 connected to the first phase connection 94 surrounds the conductive track 706 connected to the second phase connection 96, the latter conductive track 706 surrounding the conductive track 704 connected to the third phase connection 98. This arrangement allows the first, second and third phase connections 28, 26, 24 of the first terminal block 2 to be placed opposite the first, second and third phase connections 94, 96, 98 of the second terminal block 9 to facilitate their connection to the power electronics module, as in the first embodiment of the invention.

In this second embodiment of the invention, the second phase connection 26 of the first terminal block 2 is located angularly between the first two connection terminals 3061 and 3062 electrically connected to this second phase connection 26, on the first circular bus 30.

Similarly, the second phase connection 96 of the second terminal block 9 is angularly located between the first two connection terminals 7061 and 7062 electrically connected to this second phase connection 96, on the circular bus 70.

Thus, by positioning the first terminal block 2 opposite the second terminal block 9 when assembling the electric machine 100, all the connection terminals of the first circular bus 30 connected to the second phase connection 26 face the connection terminals of the second circular bus 70 connected to the second phase connection 96, which means that the coils 8 facing each other may be supplied with the same current generating a magnetic flux oriented in the same direction.

Alternative embodiments are possible by angularly offsetting the second terminal block 9 from the first terminal block 2, in particular by an angle that is a multiple of the angle a.

In this second embodiment of the invention, the structures of the first and second circular buses 30, 70 are identical, but one must be rotated relative to the other so as to position two connection terminals connected to the second phase connection 26 of the first circular bus 30 opposite two connection terminals connected to the second phase connection 96 of the second circular bus 70, in order to obtain a correct power supply to the coils 8 of the electric machine 1. This also amounts to positioning the connection terminal 3061 opposite the connection terminal 7062, which means that an indexing device may be provided on the first circular bus aimed more specifically at positioning, in the connection sequence of the first circular bus which is structurally identical to the connection sequence of the second circular bus, the first connection terminal of the sequence of the first circular bus connected to the second phase connection, opposite the second connection terminal of the sequence of the second circular bus connected to the second phase connection.

A method for assembling the electric machine 1 or 100 according to the invention is now described in relation to FIG. 9.

In the first and second embodiments of the invention, it is assumed that the housing 12 is made up of two half-housings each comprising the first or the second stator, the two half-housings having to be screwed together by gripping the rotor in order to close the housing 12.

A first step 200 of the method is the electrical connection of the first, second and third supply phase connections 28, 26, 24 to the first circular bus 3 or 30. This step is carried out by welding the cylinders constituting the connections of the phases 28, 26, 24 to the conductive tracks 34, 36, 38 or 304, 306, 308. The second phase connection 26 is angularly positioned at the same position as the connection terminal 361 to which it is electrically connected in the first embodiment, or between the connection terminals 3061, 3062 to which it is electrically connected in the second embodiment.

A second step 400 of the method is the electrical connection of the first, second and third supply phase connections 94, 96, 98 to the second circular bus 7 or 70. This step 400 is carried out in a similar way to step 200, the structures of the first and second circular buses being identical.

A third step 600 of the method is to position the first circular bus 3 or 30 in the first housing segment by inserting the first terminal block 2 in the hole 124 of this first housing segment,

A fourth step 800 is to position the second circular bus 7 or 70 in the second housing segment by inserting the second terminal block 9 in the hole 126 in this second housing segment,

A fifth step 1000 is the electrical connection of the coils 8 of the first stator 4 or 40 to the connection terminals of the first circular bus 3 or 30, by crimping each coil end 8 angularly disposed at the same position as a connection terminal of the first circular bus 3 or 30, into this connection terminal. This step involves attaching the stator yoke of the stator 4 or 40, on which the coils 8 of the stator 4 or 40 are mounted, to the half-housing housing the stator 4 or 40.

A sixth step 1200 is the electrical connection of the coils 8 of the second stator 6 or 60 to the connection terminals of the second circular bus 7 or 70, by crimping each coil end 8 angularly disposed at the same position as a connection terminal of the second circular bus 7 or 70, into this connection terminal. This step involves attaching the stator yoke of the stator 6 or 60, on which the coils 8 of the stator 6 or 60 are mounted, to the half-house housing the stator 6 or 60.

It should be noted that the stator yokes are attached in the half-housing so that the stator teeth face each other when the housing 12 is mounted. To achieve this, the half-housing are marked, for example, so that the stator teeth may be positioned at any angle. The position of the stator teeth also determines the position of the coils 8, independently of each other, in relation to the holes 124, 126 configured to receive the first and second terminal blocks 2, 9. For example, in the diagram in FIG. 4, the stator teeth are arranged at an angle so that the first and second phase connections of each terminal block are connected to the same coil 8.

A seventh step, 1400, involves installing the rotor between the two stators 4, 40 and 6, 60, in particular by positioning the shaft of the rotor in the passage orifices 122 provided for this purpose.

Finally, step 1600 closes the housing 12 by screwing the two half-housings together.

The order of these steps is not fixed, and may be modified in alternative embodiments of the assembly method according to the invention. In particular, depending on the arrangement of the coil outputs compared with circular buses, the attachment of the stator yokes in the half-housings may be connected before the coils are connected to the circular buses.

Of course, the invention is not limited to the examples just described, and many adjustments may be made to these examples without going beyond the scope of this invention.

1-13. (canceled)

14. A three-phase axial-flux electric machine, comprising:
a housing comprising a first segment housing a first stator and a second segment housing a second stator;
a rotor configured to rotate about an axis of rotation, housed in the housing between the first stator and the second stator;
the first stator and the second stator, which each comprise coils and which respectively comprise a first and a second three-phase circular bus, the first and second circular buses comprising each conductive tracks on which are arranged connection terminals of the coils, wherein the first circular bus, the second circular bus, and the coils of the first and of the second stator are structurally identical;
at least a first, a second, and a third supply phase connection on the first and on the second stator, each electrically connected to one of the conductive tracks of the first and of the second circular bus respectively, and each configured to be supplied by a first, a second, and a third supply phase respectively at an output of at least one power electronics module; and
at least one first device configured to index a position of the first circular bus in the first housing segment, and at least one second device configured to index a position of the second circular bus in the second housing segment, the first and second indexing devices being configured to position in the housing a predetermined connection terminal from among the connection terminals of the first circular bus, electrically connected to the second phase connection of the first stator, opposite a predetermined connection terminal among the connection terminals of the second circular bus, electrically connected to the second phase connection of the second stator, the electrical connections of the first and third phase connections to the conductive tracks being reversed on the first stator relative to the second stator.

15. The electric machine according to claim 14, wherein the first indexing device is a first terminal block attached to the first circular bus and configured to nest into a dedicated location of the first housing segment, and the second indexing device is a second terminal block attached to the second circular bus and configured to nest into a dedicated location of the second housing segment, the first terminal block and the second terminal block comprising the first, the second, and the third phase connection of the first circular bus and of the second circular bus respectively.

16. The electric machine according to claim 15, wherein an assembly of first circular bus and first terminal block connected to each other form a structure identical to that formed by an assembly of second circular bus and second terminal block connected to each other.

17. The electric machine according to claim 14, wherein the coils of the first stator are connected in star, the coils of the second stator are connected in star, wherein the connection terminals of the coils of the first and respectively of the second stator define, on one face of the first and respectively of the second circular bus having the connection terminals, a same sequence being repeated in rotation through a predetermined angle in a clockwise direction, and wherein the position of the predetermined connection terminal on the first circular bus and the position of the predetermined connection terminal on the second circular bus are identical in the sequence of connection terminals of the first and second circular buses.

18. The electric machine according to claim 15, wherein the coils of the first and of the second stator are star-connected, and wherein the second phase connection of the first terminal block is angularly located at the same position as the predetermined connection terminal of the first circular bus.

19. The electric machine according to claim 15, wherein the coils of the first and of the second stator are star-connected, wherein a number of pole pairs of the electric machine is odd and wherein the second phase connection of the first terminal block is located angularly at 180° with respect to the predetermined connection terminal of the first circular bus.

20. The electric machine according to claim 14, wherein the coils of the first and of the second stator are connected in star and wherein the first circular bus and the second circular bus each comprise a conductive track of neutral point to which all the coils of the first stator and all the coils of the second stator are connected respectively.

21. The electric machine according to claim 14, wherein the coils of the first stator are connected in delta, the coils of the second stator are connected in delta, wherein the connection terminals of the coils of the first and respectively of the second stator define, on a face of the first and of the second circular bus respectively having the connection terminals, a same sequence being repeated in rotation through a predefined angle in a clockwise direction, and wherein the predetermined connection terminal on the first circular bus corresponds to the connection terminal immediately following the predetermined connection terminal on the second circular bus in the sequence of connection terminals of the first and second circular buses.

22. The electric machine according to claim 15, wherein the coils of the first stator are connected in delta, the coils of the second stator are connected in delta, wherein the connection terminals of the coils of the first and respectively of the second stator define, on a face of the first and of the second circular bus respectively having the connection terminals, the same sequence being repeated in rotation through a predefined angle in a clockwise direction, wherein the predetermined connection terminal on the first circular bus corresponds to the connection terminal immediately following the predetermined connection terminal on the second circular bus in the sequence of connection terminals of the first and second circular buses, and wherein the second phase connection of the first terminal block is located angularly between two connection terminals of the first circular bus, electrically connected to the second phase connection of the first stator.

23. The electric machine according to claim 15, wherein the conductive tracks of the first circular bus form an external ring connected to the third phase connection, an intermediate ring surrounded by the external ring and connected to the second phase connection, and an internal ring surrounded by the intermediate ring and connected to the first phase connection, while the conductive tracks of the second circular bus form an external ring connected to the first phase connection, an intermediate ring surrounded by the external ring and connected to the second phase connection, and an internal ring surrounded by the intermediate ring and connected to the third phase connection, the first, second, and third phase connections of the first terminal block being respectively placed opposite the first, second, and third phase connections of the second terminal block.

24. The electric machine according to claim 23, further comprising conductive bars electrically connecting the first, second, and third phase connections of the first terminal block to the first, second, and third phase connections of the second terminal block, the conductive bars each comprising an electrical connection terminal configured to receive a connecting member for electrical connection to a supply phase of said at least one power electronics module.

25. A method for assembling the electric machine according to claim 14, comprising:
connecting electrically the first, second, and third supply phase connections to the first circular bus;
connecting electrically the first, second, and third supply phase connections to the second circular bus;
positioning the first circular bus in the first housing segment using the at least one first indexing device;
positioning the second circular bus in the second housing segment using the at least one second indexing device;
connecting electrically the coils of the first stator to the connection terminals of the first circular bus;
connecting electrically the coils of the second stator to the connection terminals of the second circular bus;
installing the rotor; and
closing the housing.

26. The method as claimed in claim 25, wherein the first indexing device is a first terminal block attached to the first circular bus and configured to nest into a dedicated location of the first housing segment, and the second indexing device is a second terminal block attached to the second circular bus and configured to nest into a dedicated location of the second housing segment, the first terminal block and the second terminal block comprising the first, the second, and the third phase connection of the first circular bus and of the second circular bus respectively, wherein the connecting electrically the first, second, and third supply phase connections to the first circular bus and to the second circular bus correspond to attaching the first terminal block to the first circular bus and attaching the second terminal block to the second circular bus, and wherein the positioning the first circular bus in the first housing segment and positioning the second circular bus in the second housing segment include positioning the first terminal block and respectively the second terminal block in a dedicated location of the first housing segment and respectively the second housing position.
